(19) United States
(12) Patent Application Publication
(10) Pub. No.: US 2003/0156412 A1
(43) Pub. Date: Aug. 21, 2003

(54) Safety cap for light strings

(76) Inventors: Jamie A. Limber, Gilbert, AZ (US); Robert I. Vasquez, Phoenix, AZ (US)

Correspondence Address: The Halvorson Law Firm, 405 W. Southern Ave. Ste 1, Tempe, AZ, 85282, US

(21) Appl. No.: 10/078,692

(22) Filed: Feb. 19, 2002

(51) Int. Cl. F21V 21/00

(52) U.S. Cl. 362/249; 362/226

(57) ABSTRACT

Described is a device that is inserted into or over an empty light bulb holder, preferably one in an ornamental light string. The preferred device includes a central portion with a first raised edge on the periphery of a first side of the central portion and a second raised edge set back from the periphery of a second side of the central portion. Alternate embodiments include screw threading on the outer diameter of the second raised edge and an electrical shunt that projects from the second side of this device. While the preferred use of the present invention is for ornamental light strings, it may also be used with individual empty light bulb holders.

### FIELD OF THE INVENTION

The present invention relates to the field of safety devices. More specifically, the present invention relates to the field safety devices that are used with ornamental light strings.

### BACKGROUND

Ornamental light strings are popular decorations for both business and homes. These light strings come in a variety of different lengths, bulb sizes, and configurations.

It is not uncommon for an entire light string to cease operation when a single bulb of the string bums out or breaks. However, there are light strings where the remaining lights continue to operate with a burnt, broken, or even missing light in the string array. When there are broken or missing light bulbs in these arrays, there is a danger of accident contact with the electrodes of either the broken bulb or empty bulb holder.

Thus, it can be clearly seen that there is a need for a device that can easily be used with bulb holders of ornamental light strings and that help prevent accidental contact with exposed electrical contacts.

### SUMMARY OF INVENTION

It is an object of the present invention to provide a device for use with ornamental light strings.

It is another object of the present invention to provide a device that is used with empty bulb holders in ornamental light strings.

It is yet another object of the present invention to provide a device that can be inserted into/on an empty bulb holder of an ornamental light strings and which will prevent accidental contact with exposed electrical contacts.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWING

FIG. 1 is perspective view of the device according to the present invention.

FIG. 2 is a view of the first side of the device according to the present invention.

FIG. 3 is a view of the second side of the device according to the present invention.

FIG. 4 illustrates how the device according to the present invention is inserted into an empty light bulb holder of a light string.

FIG. 5 illustrates the alternate embodiment of the device according to the present invention that has screw threads.

FIG. 6 is a perspective view of the embodiment of the present invention having a projecting electrical shunt.

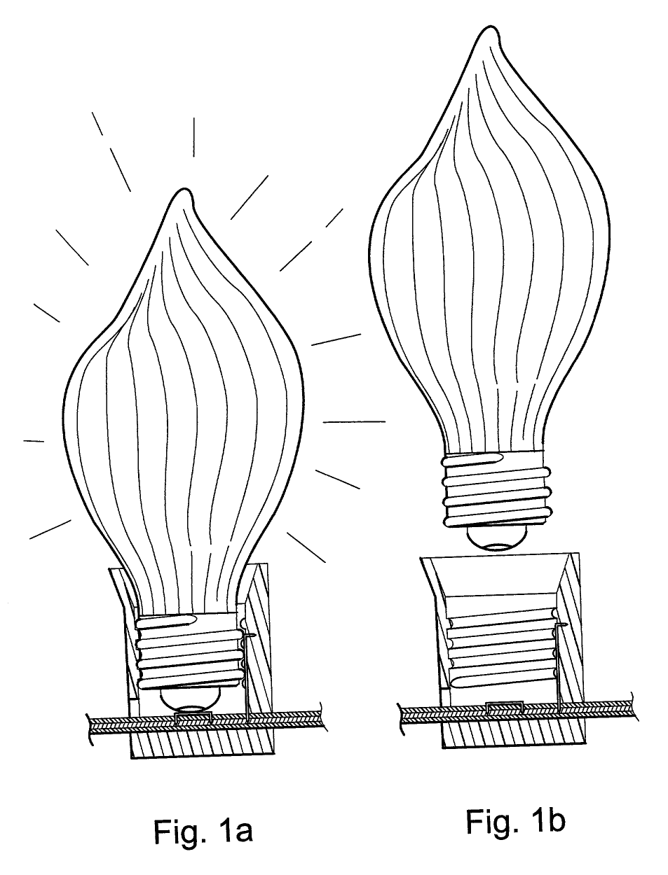

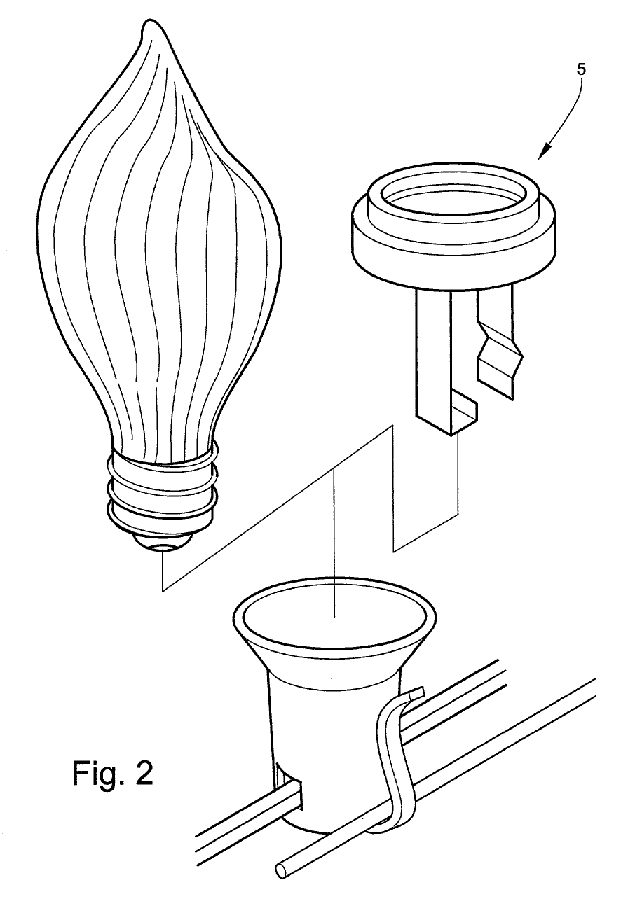

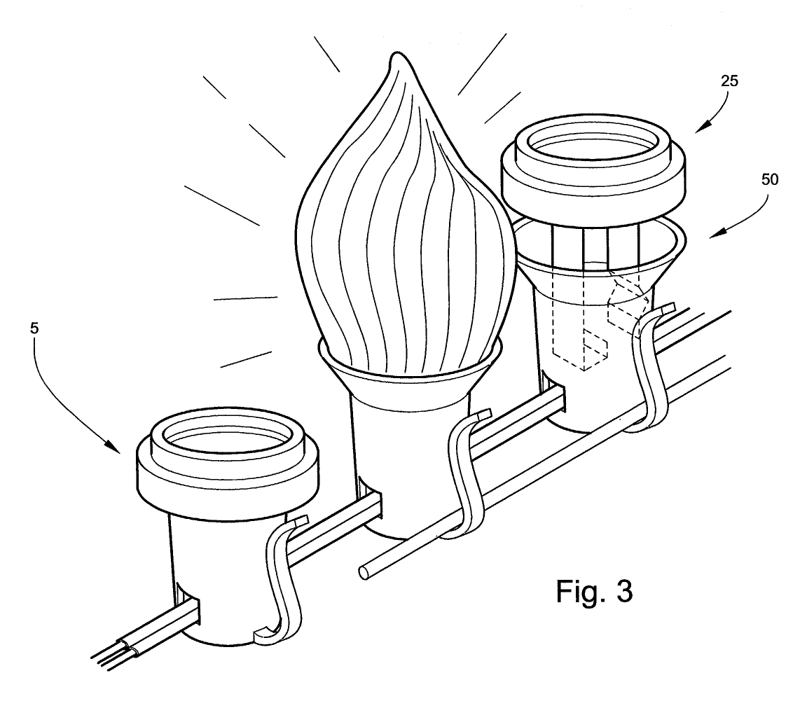

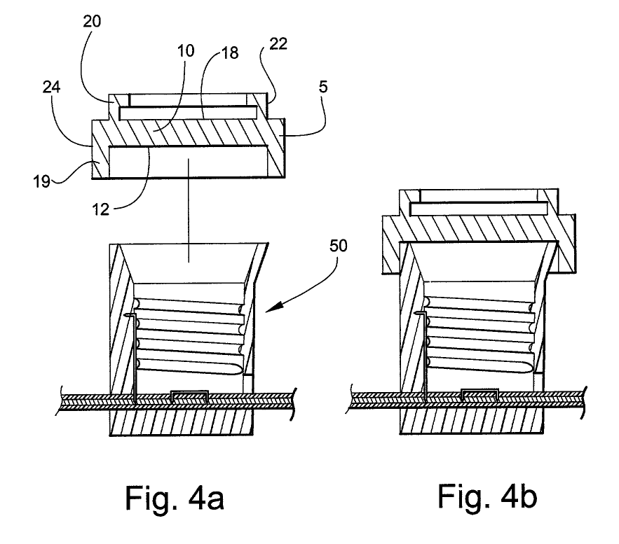

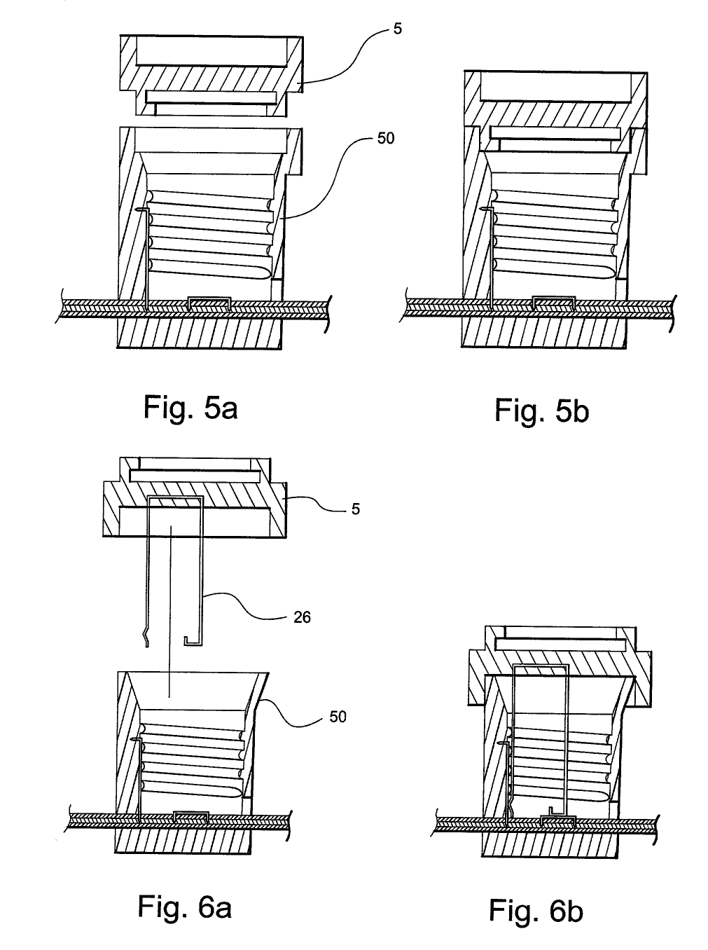

### DETAILED DESCRIPTION OF PREFERRED EMBODIMENTS

The present invention is useful for helping prevent accidental contact with exposed electrical contacts in an ornamental light string.

The device 5 of the present invention is a cap 5 that is sized to be inserted into or on an empty light bulb holder of an ornamental light string. In its simplest form, the device 5 of the present invention may be a central portion 10 having a first side 12, a second side 18, and a perimeter 24. In this embodiment, the perimeter 24 of the central portion 10 must be sized to fit snuggly within the empty light bulb socket 50, thereby covering any exposed electrical contacts. Further, the central portion 10 should be sized with a thickness that would be sufficient to project from the empty light bulb holder 50, thus providing a gripping or tension surface for removal of the central portion 10 when a light bulb is desired to be inserted into the empty light bulb holder 50.

However, the preferred embodiment of the cap 5 according to the present invention has a flat, circularly shaped central portion 10. On the perimeter 24 of the first side 12 of the central portion 10 is a gripping raised edge 14, which when combined with the central portion 10, defines a first depression.

On the second side 18 of the central portion 10 there is an insertion raised edge 20, set in from the perimeter 24 of the central portion 10. It is critical that this insertion raised edge 20 have an outside diameter that is generally the same as the inside diameter of an empty light bulb holder 50. This is to ensure that the insertion raised edge 20 can be fit frictionally and snuggly into the empty light bulb holder 50. Alternately, the outer diameter of the insertion raised edge 22 may include screw threads that are sized to mateingly be received by the screw threads within an empty light bulb holder 50.

In yet another embodiment of the present invention, the insertion raised edge 20 may be sized such that the inner diameter is generally the same as the outer diameter of the empty light bulb holder 50. Thus, the device 5 of the present invention snuggly and frictionally fits over the top of an empty light bulb holder 50 thereby preventing water or other unwanted devices or debris from entering the empty light bulb holder.

Since there are two sides to the device 5 of the present invention, it is clearly seen that they two different sides may be sized to fit into/over two differently sized light bulb holders 50. In this way, a single piece may be used for two different strings. Currently, the preferred sizes are known in the industry as C-9 and C-7.

By inserting (or screwing) the device 5 of the present invention into or onto an empty light bulb holder 50 in an ornamental light string, the string may be used safely without fear of accidentally touching any exposed electrical contacts (since the device covers what would have been exposed contacts).

In an alternate embodiment, the device of the present invention 5 may include an electrical shunt 24 that projects from the second side 18 of the central portion 10. The electrical shunt 26 contact both exposed electrical contacts within the empty light bulb holder 50 and provides a pathway for the flow of electricity in the light string that mimics an actual bulb. Thus, this embodiment of the device 5 according to the present invention may be used with light strings that cease to work when a bulb is removed from the string.

Finally, it must be realized that the device 5 of the present invention may be used with any empty light bulb holder, whether in a light string or individually, to help prevent accident contact with exposed electrical contacts.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1) A device comprising a central portion comprising a first side, a second side and a perimeter sized to snuggly fit within or over an empty light bulb holder.

2) The device according to claim 1 farther including screw threads on the perimeter of the device.

3) A device comprising a central portion comprising
a) a perimeter,
b) a first side further comprising a gripping raised edge along the perimeter that is sized to fit within an empty light bulb holder, and
c) a second side further comprising an insertion raised edge that is sized to fit within an empty light bulb holder.

4) The device according to claim 3 wherein the insertion raised edge further comprises screw threads on an outer diameter of the insertion raised edge.

5) The device according to claim 3 further comprising an electrical shunt projecting from the second side.

6) The device according to claim 4 further comprising an electrical shunt projecting from the second side.

7) A device comprising a central portion comprising
a) a perimeter,
b) a first side further comprising a gripping raised edge along the perimeter that is sized to fit over an empty light bulb holder, and
c) a second side further comprising an insertion raised edge that is sized to fit over an empty light bulb holder.

8) The device according to claim 7 father comprising an electrical shunt projecting from the second side.
